(19) United States
(12) Patent Application Publication
(10) Pub. No.: US 2012/0042644 A1
(43) Pub. Date: Feb. 23, 2012

(54) MOBILE HYDRAULIC SYSTEM

(75) Inventor: Bjoern Noack, Bangalore (IN)

(73) Assignee: ROBERT BOSCH GMBH, Stuttgart (DE)

(21) Appl. No.: 13/203,156

(22) PCT Filed: Jan. 25, 2010
(86) PCT No.: PCT/EP2010/050781

§ 371 Date: Nov. 8, 2011

(30) Foreign Application Priority Data
Feb. 24, 2009 (DE) 10 2009 001 107.2

(51) Int. Cl. F15B 1/24; F15B 13/042

(52) U.S. Cl. 60/417; 91/437; 91/440

(57) ABSTRACT

The invention relates to a mobile hydraulic system for a hybrid vehicle, comprising a hydraulic accumulator device (22), which comprises a high-pressure accumulator chamber (34) and a low-pressure accumulator chamber (35), between which a hydraulic drive unit is connected, wherein the hydraulic drive unit is used to convey an incompressible fluid from the low-pressure accumulator chamber (35) into the high-pressure accumulator chamber (34) in an accumulator operating state, wherein the incompressible fluid can be discharged from the high-pressure accumulator chamber into the low-pressure accumulator chamber (35) in a drive operating state in order to hydraulically drive the hydraulic drive unit. In order to further reduce the space requirement for the hydraulic accumulator device in the mobile hydraulic system, the low-pressure accumulator chamber (35) and the high-pressure accumulator chamber (34) are fluidically separated by a separating device (36) and arranged in a common accommodating chamber (25) in which a variable compensating volume (50) having a compressible fluid is also arranged.

### BACKGROUND OF THE INVENTION

The invention relates to a mobile hydraulic system for a hybrid vehicle, having a hydraulic accumulator device, which comprises a high-pressure accumulator chamber and a low-pressure accumulator chamber, between which a hydraulic drive unit is connected, which is used to deliver an incompressible fluid from the low-pressure accumulator chamber into the high-pressure accumulator chamber in an accumulator operating state, from which the incompressible fluid can be discharged into the low-pressure accumulator chamber in a drive operating state in order to hydraulically drive the hydraulic drive unit.

German Laid-Open Application DE 10 2006 060 078 A1 has disclosed a hydraulic accumulator for a mobile hydraulic system having a separating element which is arranged within an accumulator housing in such a way that it can move and which separates two fluid chambers from one another within the accumulator housing. One fluid chamber contains a compressible fluid, while the other fluid chamber contains an incompressible fluid. In order to reduce the space requirement for the hydraulic accumulator, the accumulator housing is accommodated in a structural component of the mobile hydraulic system.

### SUMMARY OF THE INVENTION

It is the object of the invention to achieve a further reduction in the space requirement for a hydraulic accumulator device in a mobile.

The object is achieved, in a mobile hydraulic system for a hybrid vehicle, having a hydraulic accumulator device, which comprises a high-pressure accumulator chamber and a low-pressure accumulator chamber, between which a hydraulic drive unit is connected, which is used to deliver an incompressible fluid from the low-pressure accumulator chamber into the high-pressure accumulator chamber in an accumulator operating state, from which the incompressible fluid can be discharged into the low-pressure accumulator chamber in a drive operating state in order to hydraulically drive the hydraulic drive unit, by virtue of the fact that the low-pressure accumulator chamber and the high-pressure accumulator chamber are fluidically separated by a separating device and arranged in a common accommodating chamber, in which a variable compensating volume containing a compressible fluid is also arranged. In the mobile hydraulic system known from German Laid-Open Application DE 10 2006 060 078 A1, the incompressible fluid is delivered into the hydraulic accumulator comprising the high-pressure accumulator chamber from a tank constituting the low-pressure accumulator chamber, for example. According to an essential aspect of the invention, two hydraulic accumulators are as it were combined in a common accommodating chamber of the hydraulic accumulator device according to the invention. According to another aspect of the invention, just one variable compensating volume is required for the low-pressure accumulator chamber and the high-pressure accumulator chamber.

A preferred illustrative embodiment of the mobile hydraulic system is characterized in that the separating device comprises a piston, which delimits the high-pressure accumulator chamber. In the accumulator operating state, the incompressible fluid is delivered into the high-pressure accumulator chamber in such a way that a pressure is exerted on the piston by the incompressible fluid.

Another preferred illustrative embodiment of the mobile hydraulic system is characterized in that the piston is acted upon or preloaded toward the high-pressure accumulator chamber by an accumulator spring. If incompressible fluid is delivered from the low-pressure accumulator chamber into the high-pressure accumulator chamber by the hydraulic drive unit in the accumulator operating state, the piston is moved counter to the spring force of the accumulator spring, which stores the hydraulic energy.

Another preferred illustrative embodiment of the mobile hydraulic system is characterized in that the variable compensating volume containing the compressible fluid is embodied as a gas bubble. The variable compensating volume absorbs volumetric changes in the fluid charge in the common accommodating chamber. Such volumetric changes can arise from changes in density due to pressure and temperature.

Another preferred illustrative embodiment of the mobile hydraulic system is characterized in that the variable compensating volume containing the compressible fluid is arranged in the low-pressure accumulator chamber. The variable compensating volume is preferably arranged at the opposite end of the low-pressure accumulator chamber from the high-pressure accumulator chamber.

Another preferred illustrative embodiment of the mobile hydraulic system is characterized in that the separating device comprises a further piston, which delimits the low-pressure accumulator chamber. The further piston, like the first-mentioned piston, is guided in such a way that it can be moved backward and forward in the common accommodating chamber.

Another preferred illustrative embodiment of the mobile hydraulic system is characterized in that the compensating volume is provided between the two pistons. The compensating volume between the two pistons is preferably filled with gas and serves to absorb volumetric changes in the fluid charge in the common accommodating chamber. Such volumetric changes can arise from changes in density due to pressure and temperature.

Another preferred illustrative embodiment of the mobile hydraulic system is characterized in that an intermediate spring is arranged or clamped between the two pistons. The intermediate spring, like the accumulator spring, is a helical compression spring, for example.

The invention furthermore relates to a hydraulic hybrid vehicle having a mobile hydraulic system as described above. In the hydraulic hybrid vehicle, the hydraulic accumulator device according to the invention is used to store energy that is produced as the wheels are braked, for example, and to use it to assist the drive system of the vehicle, when accelerating for example.

Further advantages, features and details of the invention will emerge from the following description, in which various illustrative embodiments are described in detail with reference to the drawing.

### BRIEF DESCRIPTION OF THE DRAWINGS

FIG. 1 shows a greatly simplified illustration of a mobile hydraulic system for a hybrid vehicle having a hydraulic accumulator device comprising two separate hydraulic accumulators;

FIG. 2 shows a simplified illustration of a hydraulic accumulator device in accordance with a first illustrative embodiment of the invention, having two pistons and a variable compensating volume, and

FIG. 3 shows a similar illustrative embodiment to that in FIG. 2, having a piston and a variable compensating volume.

### DETAILED DESCRIPTION

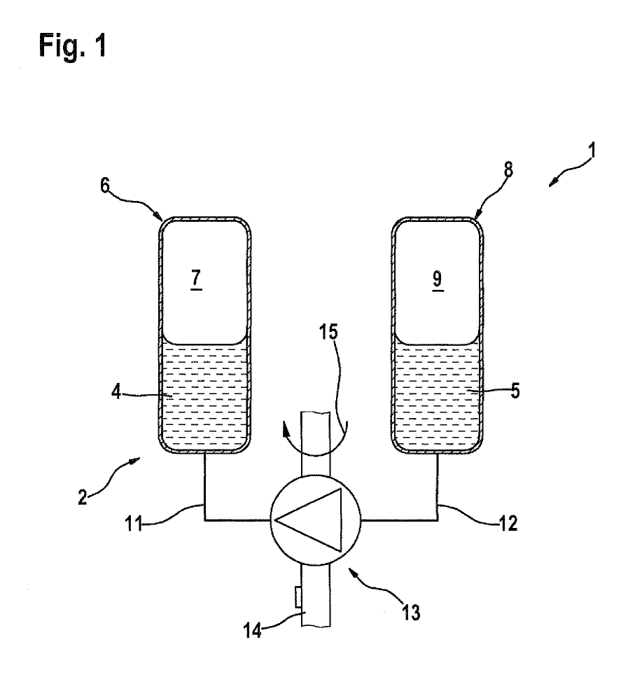

FIG. 1 gives a greatly simplified illustration of a mobile hydraulic system 1 having a hydraulic accumulator device 2. The hydraulic accumulator device 2 comprises a high-pressure accumulator chamber 4 and a low-pressure accumulator chamber 5 for an incompressible fluid, such as hydraulic oil. The high-pressure accumulator chamber 4 is provided in a hydraulic accumulator 6, which is embodied as a bubble-type accumulator with a gas bubble 7. The low-pressure accumulator 5 is provided in a separate hydraulic accumulator 8, which is likewise embodied as a bubble-type accumulator with a gas bubble 9.

A fluid line 11 for the incompressible fluid starts from the high-pressure accumulator chamber 4 of hydraulic accumulator 6. Similarly, another fluid line 12 for the incompressible fluid starts from the low-pressure accumulator chamber 5 of hydraulic accumulator 8. Fluid line 11 connects the high-pressure accumulator chamber 4 fluidically or hydraulically to an output of a hydraulic drive unit 13. The other fluid line 12 connects the low-pressure accumulator chamber 5 fluidically or hydraulically to an input of the hydraulic drive unit 13.

The hydraulic drive unit 13 is a hydraulic pump/motor unit with a shaft 14 which, as indicated by an arrow 15, can be rotated. If the hydraulic drive unit 13 is driven in the direction of arrow 15 by way of the shaft 14, incompressible fluid is delivered from the low-pressure accumulator chamber 5 into the high-pressure accumulator chamber 4 via the hydraulic drive unit 13 in an accumulator operating state of the hybrid vehicle. The associated hydraulic energy is stored in the hydraulic accumulator 6.

In a drive operating state, incompressible fluid can be discharged from the high-pressure accumulator chamber 4 into the low-pressure accumulator chamber 5 via the hydraulic drive unit 13, and the shaft 14 is driven hydraulically by the hydraulic drive unit 13 counter to the direction of arrow 15. In buses or trucks, for example, it is thus possible for energy stored during braking to be used to assist an electric-motor or combustion-engine drive system during acceleration.

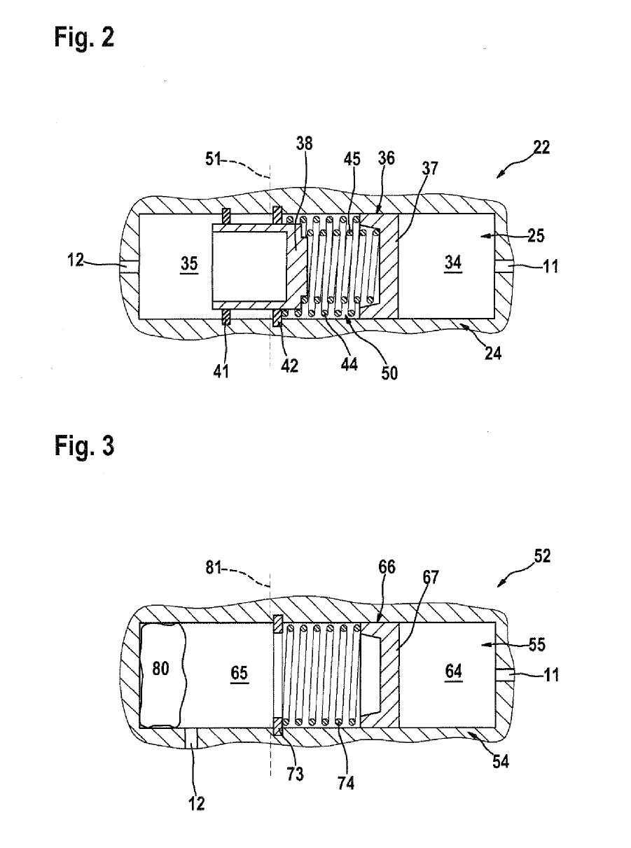

FIG. 2 gives a simplified illustration of a hydraulic accumulator device 22 having an accumulator housing 24, which delimits a common accommodating chamber 25. The common accommodating chamber 25 comprises both a high-pressure accumulator chamber 34 and a low-pressure accumulator chamber 35 for an incompressible fluid, such as hydraulic oil. The two accumulator chambers 34, 35 for the incompressible fluid are separated hydraulically from one another by a separating device 36. The separating device 36 comprises a first piston 37, which delimits the high-pressure accumulator chamber 34, and a second piston 38, which delimits the low-pressure accumulator chamber 35. The two pistons 37, 38 are accommodated in the common accommodating chamber 25 in such a way that they can be moved backward and forward.

The second piston 38 is guided with the aid of two annular guiding and/or sealing devices 41, 42 in such a way that it can be moved backward and forward. In this arrangement, the second guiding and/or sealing device 42 simultaneously serves as an axial stop for an accumulator spring 44 of the first piston 37. The accumulator spring 44 is arranged or clamped between the guiding and/or sealing device 42 and the first piston 37. Moreover, an intermediate spring 45 is arranged or clamped between the two pistons 37, 38. Like the accumulator spring 44, the intermediate spring 45 is embodied as a helical compression spring but is arranged radially within the accumulator spring 44.

In addition to accommodating the two springs 44 and 45, the intermediate chamber between the two pistons 37 and 38 serves as a compensating volume 50, which is preferably filled with a gas, such as nitrogen. By constructing the hydraulic accumulator device 22 in accordance with the invention, it is possible to reduce the compensating volume 50 to the minimum requirement for density compensation. It is thereby possible to significantly increase the energy density of the mobile hydraulic system.

In the accumulator operating state, which is also referred to as the pumping operating state, incompressible fluid is delivered from the low-pressure accumulator chamber 35 into the high-pressure accumulator chamber 34 via fluid line 12, the hydraulic drive unit 13 and fluid line 11. During this process, the two pistons 37, 38 are pushed to the left in FIG. 2. In the drive operating state, which is also referred to as the motor operating state, incompressible fluid is taken from the high-pressure accumulator chamber 34 and, during this process, the accumulator spring 44 behind the first piston 37 expands and, in doing so, stabilizes the high pressure.

FIG. 3 gives a simplified illustration of a hydraulic accumulator device 52 having an accumulator housing 54 and a common accommodating chamber 55 for a high-pressure accumulator chamber 64 and a low-pressure accumulator chamber 65 for incompressible fluid. The two accumulator chambers 64, 65 for the incompressible fluid are separated from one another hydraulically by a separating device 66. The separating device 66 comprises a piston 67, which can be moved backward and forward in the common accommodating chamber 55.

An accumulator spring 74 is arranged or clamped between a stop device 73 fixed relative to the accumulator housing and the piston 67 of the separating device 66. The low-pressure accumulator chamber 65 contains a compensating volume 80 in the form of a gas bubble, which is filled with a gas, such as nitrogen. The illustrative embodiment shown in FIG. 3 operates in a manner similar to the illustrative embodiment shown in FIG. 2.

Dashed lines 51; 81 in FIGS. 2 and 3 indicate a boundary separating a low-pressure region from a high-pressure region. Owing to the lower pressure loading, the low-pressure region can be designed differently with respect to the materials used and/or wall thicknesses of the accumulator housing 54 than the high-pressure region.

1. A mobile hydraulic system for a hybrid vehicle, the hydraulic system comprising:
a hydraulic accumulator device (2; 22; 52) having a high-pressure accumulator chamber (4; 34; 64) and a low-pressure accumulator chamber (5; 35; 65), and
a hydraulic drive unit (13) connected with each of the high-pressure accumulator chamber (4; 34; 64) and the low-pressure accumulator chamber (5; 35; 65), the hydraulic drive unit (13) being used to deliver an incompressible fluid from the low-pressure accumulator chamber (5; 35; 65) into the high-pressure accumulator chamber (4; 34; 64) in an accumulator operating state, and from which the incompressible fluid can be discharged into the low-pressure accumulator chamber (5; 35; 65) in a drive operating state in order to hydraulically drive the hydraulic drive unit (13), characterized in that the low-pressure accumulator chamber (35; 65) and the high-pressure accumulator chamber (34; 64) are fluidically separated by a separating device (36; 66) and arranged in a common accommodating chamber (25; 55), in which a variable compensating volume (50; 80) containing a compressible fluid is also arranged.

2. The mobile hydraulic system as claimed in claim 1, characterized in that the separating device (36; 66) comprises a piston (37; 67), which delimits the high-pressure accumulator chamber (34; 64).

3. The mobile hydraulic system as claimed in claim 2, characterized in that the piston (37; 67) is at least one of acted upon and preloaded toward the high-pressure accumulator chamber (34; 64) by an accumulator spring (44; 74).

4. The mobile hydraulic system as claimed in claim 1, characterized in that the variable compensating volume (80) containing the compressible fluid is embodied as a gas bubble.

5. The mobile hydraulic system as claimed in claim 1, characterized in that the variable compensating volume (80) containing the compressible fluid is arranged in the low-pressure accumulator chamber (35).

6. The mobile hydraulic system as claimed in claim 2, characterized in that the separating device (36) comprises a further piston (38), which delimits the low-pressure accumulator chamber (35).

7. The mobile hydraulic system as claimed in claim 6, characterized in that the compensating volume (50) is provided between the two pistons (37, 38).

8. The mobile hydraulic system as claimed in claim 6, characterized in that an intermediate spring (45) is at least one of arranged and clamped between the two pistons (37, 38).

9. (canceled)

10. The mobile hydraulic system as claimed in claim 7, characterized in that an intermediate spring (45) is at least one of arranged and clamped between the two pistons (37, 38).
